(19) United States
(12) Patent Application Publication
(10) Pub. No.: US 2024/0184595 A1
(43) Pub. Date: Jun. 6, 2024

(54) INTERACTIVE SYSTEM FOR AUTOMATIC EXECUTION OF PLUGINS

(71) Applicant: Figma, Inc., San Francisco, CA (US)

(72) Inventors: Sawyer Hood, San Francisco, CA (US); Bersabel Tadesse, San Francisco, CA (US); Ahmed Abdalla, San Francisco, CA (US); Yi Tang Jackie Chui, San Francisco, CA (US)

(21) Appl. No.: 18/531,684

(22) Filed: Dec. 6, 2023

Related U.S. Application Data
(60) Provisional application No. 63/430,663, filed on Dec. 6, 2022.

(51) Int. Cl. G06F 9/445; G06F 9/451

(52) U.S. Cl. CPC G06F 9/44526; G06F 9/451

(57) ABSTRACT

An interactive system is configured to be extensible, allowing use of plugins that detect content entry input of each of the one or more users on a user-generated content of a canvas. In response to detecting each content entry input, (i) the interactive system (i) automatically triggers execution of a plugin, the plugin being implemented as a program that executes separately from the interactive system; and (ii) renders at least a first output generated by execution of the plugin with the user-created content.

### RELATED APPLICATIONS

This patent application claims benefit of priority to Provisional U.S. Patent Application No. 63/430,663, filed Dec. 6, 2022; the aforementioned priority application being hereby incorporated by reference for all purposes.

### TECHNICAL FIELD

Examples described herein relate to an interactive system for automatic execution of plugins.

### BACKGROUND

Software design tools have many forms and applications. In the realm of application user interfaces, for example, software design tools require designers to blend functional aspects of a program with aesthetics and even legal requirements, resulting in a collection of pages which form the user interface of an application. For a given application, designers often have many objectives and requirements that are difficult to track.

### BRIEF DESCRIPTION OF THE DRAWINGS

FIG. 1A illustrates an interactive system for a computing device of a user, according to one or more examples.

FIG. 1B illustrates a network computing system to implement an interactive system on a user computing device, according to one or more examples.

FIG. 1C illustrates a network computing system to implement an interactive system for multiple users in a collaborative network platform, according to one or more examples.

FIG. 2 illustrates a plugin management system for use with examples as described with FIG. 1A through FIG. 1C.

FIG. 3A and FIG. 3B describe example methods for executing plugins in connection with content entry on a canvas, according to one or more embodiments.

FIG. 4A through FIG. 4B illustrate example interfaces which can be generated for a canvas, according to one or more embodiments.

FIG. 4C and FIG. 4D illustrate a sequence where a content element or entry is automatically detected to cause a selected plugin to identify or generate a corresponding image, according to one or more examples.

FIG. 5 illustrates a computer system on which one or more embodiments can be implemented.

FIG. 6 illustrates a user computing device for use with one or more examples, as described.

### DETAILED DESCRIPTION

Embodiments provide for an interactive system or platform that includes a plugin management system, to enable users to search for and execute desired plugins. In examples, the plugin management system provides a search user interface to receive inputs from the user, as well as parametric values that are used by the selected plugin. Based on the user interaction with the search user interface, the plugin management system executes identified plugins, using parametric values specified by the user.

In examples, a system can integrate a plugin system to implement multiple types of plugins (e.g., multiple types of spell-checkers) in context of a graphic design system, where a functionality or output of additional plugins utilize an output or function of a programmatic component (e.g., system component, default plugin, etc.) that runs at the same time.

In examples, a computing system is configured to implement an interactive system or platform for enabling users to create various types of content, such as graphic designs, whiteboards, presentations, web pages and other types of content. Among other advantages, examples as described enable such users to utilize plugins to extend or supplement the functionality of an interactive system for their particular needs.

Still further, in some examples, a network computer system is provided to include memory resources store a set of instructions, and one or more processors are operable to communicate the set of instructions to a plurality of user devices. The set of instructions can be communicated to user computing devices, in connection with the user computing devices being operated to render a content on a canvas, where the design can be edited by user input that is indicative of any one of multiple different input actions. The set of instructions can be executed on the computing devices to cause each of the computing devices to determine one or more input actions to perform based on user input. The instructions may further cause the user computing devices to implement the one or more input actions to modify the content. In such examples, the interactive system includes a plugin management system to enable users to search for and execute plugins that extend or supplement the functionality provided by the plugin management system.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

### System Description

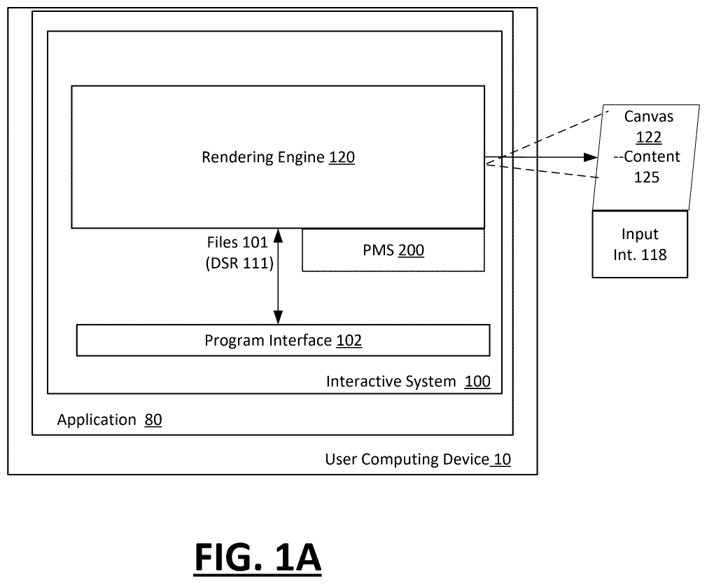

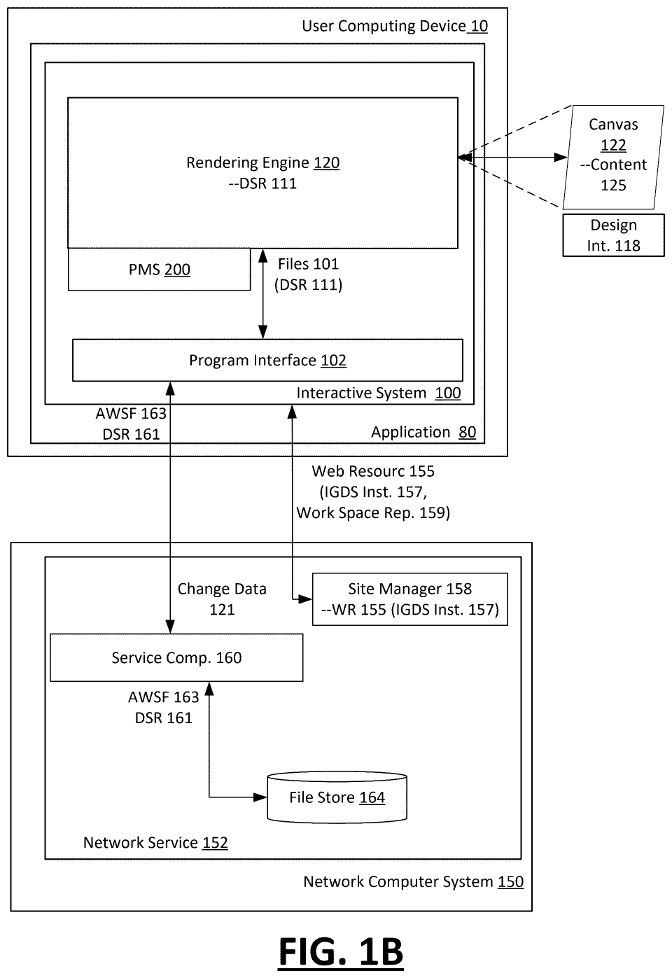

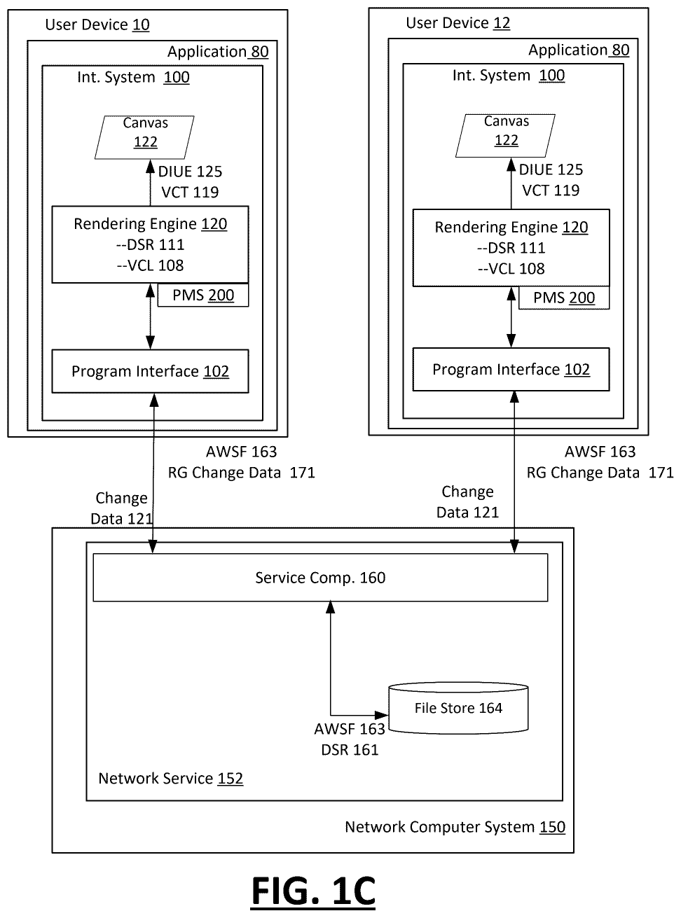

FIG. 1A illustrates an interactive system for a computing device of a user, according to one or more examples. An interactive system 100 can be implemented in any one of multiple different computing environments. For example, in some variations, the system 100 can be implemented as a client-side application that executes on the user computing device 10 to provide functionality as described with various examples. In other examples, such as described below, the system 100 can be implemented through use of a web-based application 80. As an addition or alternative, the system 100 can be implemented as a distributed computing environment, such that processes described with various examples execute on a network computer (e.g., server) and/or on the user device 10.

According to examples, interactive system 100 is implemented on a user computing device 10 to enable a corresponding user to generate content such as interactive designs and whiteboards. The system 100 can include processes that execute as or through a web-based application 80 that is installed on the computing device 10. As described by various examples, web-based application 80 can execute scripts, code and/or other logic (the “programmatic components”) to implement functionality of the interactive system 100. Additionally, in some variations, the system 100 can be implemented as part of a network service, where web-based application 80 communicates with one or more remote computers (e.g., server used for a network service) to executes processes of the system 100.

In some examples, web-based application 80 retrieves some or all of the programmatic resources for implementing the system 100 from a network site. As an addition or alternative, web-based application 80 can retrieve some or all of the programmatic resources from a local source (e.g., local memory residing with the computing device 10). The web-based application 80 may also access various types of data sets in providing functionality or services for the interactive system 100. The data sets can correspond to files and libraries, which can be stored remotely (e.g., on a server, in association with an account), locally or distributed between local and network resources.

In examples, the web-based application 80 can correspond to a commercially available browser, such as GOOGLE CHROME (developed by GOOGLE, INC.), SAFARI (developed by APPLE, INC.), and INTERNET EXPLORER (developed by the MICROSOFT CORPORATION). In such examples, the processes of the interactive system 100 can be implemented as scripts and/or other embedded code which web-based application 80 downloads from a network site. For example, the web-based application 80 can execute code that is embedded within a webpage to implement processes of the system 100. The web-based application 80 can also execute the scripts to retrieve other scripts and programmatic resources (e.g., libraries) from the network site and/or other local or remote locations. By way of example, the web-based application 80 may execute JAVASCRIPT embedded in an HTML resource (e.g., web-page structured in accordance with HTML 5.0 or other versions, as provided under standards published by W3C or WHATWG consortiums). In some examples, the rendering engine 120 and/or other components may utilize graphics processing unit (GPU) accelerated logic, such as provided through WebGL (Web Graphics Library) programs which execute Graphics Library Shader Language (GLSL) programs that execute on GPUs.

According to examples, the user of computing device 10 operates web-based application 80 to access a network site, where programmatic resources are retrieved and executed to implement the interactive system 100. In some examples, the user may initiate a session to implement the interactive system 100 for purpose of creating and/or editing a graphic design, whiteboard, presentation, a webpage or other type of content. In examples, the system 100 includes a program interface 102, an input interface 118, and a rendering engine 120. The program interface 102 can include one or more processes which execute to access and retrieve programmatic resources from local and/or remote sources.

In an implementation, the program interface 102 can generate, for example, a canvas 122, using programmatic resources which are associated with web-based application 80 (e.g., HTML 5.0 canvas). As an addition or variation, the program interface 102 can trigger or otherwise cause the canvas 122 to be generated using programmatic resources and data sets (e.g., canvas parameters) which are retrieved from local (e.g., memory) or remote sources (e.g., from network service).

The program interface 102 may also retrieve programmatic resources that include an application framework for use with canvas 122. The application framework can include data sets which define or configure, for example, a set of interactive tools that integrate with the canvas 122 and which comprise the input interface 118, to enable the user to provide input for creating and/or editing a given content (e.g., a graphic design, a whiteboard, a presentation, a webpage, etc.).

According to some examples, the input interface 118 can be implemented as a functional layer that is integrated with the canvas 122 to detect and interpret user input. The input interface 118 can, for example, use a reference of the canvas 122 to identify a screen location of a user input (e.g., ‘click’). Additionally, the input interface 118 can interpret an input action of the user based on the location of the detected input (e.g., whether the position of the input indicates selection of a tool, an object rendered on the canvas, or region of the canvas), the frequency of the detected input in a given time period (e.g., double-click), and/or the start and end position of an input or series of inputs (e.g., start and end position of a click and drag), as well as various other input types which the user can specify (e.g., right-click, screen-tap, etc.) through one or more input devices. In this manner, the input interface 118 can interpret, for example, a series of inputs as a design tool selection (e.g., shape selection based on location of input), as well as inputs to define attributes (e.g., dimensions) of a selected shape.

Additionally, the program interface 102 can be used to retrieve, from local or remote sources, programmatic resources and data sets which include files 101 which comprise an active workspace for the user. The retrieved data sets can include, for example, one or more pages that include content elements which collectively form a given content. By way of example, the content can correspond to a design interface, whiteboard, webpage, or other content medium. Each file 101 can include one or multiple data structure representations 111 which collectively define the design interface. The files 101 may also include additional data sets which are associated with the active workspace. For example, as described with some examples, the individual pages of the active workspace may be associated with a set of constraints 145. As an additional example, the program interface 102 can retrieve (e.g., from network service 152 (see FIG. 1B), from local memory, etc.) one or more types of profile information 109, such as user profile information which can identify past activities of the user of the computing device 10 when utilizing the interactive system 100. The profile information 109 can identify, for example, input types (or actions) of the user with respect to the page(s) of the active workspace, or more generally, input actions of the user in a prior time interval. In some variations, the profile information 109 can also identify historical or contextual information about individual design interfaces, as represented by corresponding data structure representations 111.

In examples, the rendering engine 120 uses the data structure representations 111 to render a corresponding content 125 on the canvas 122, wherein the content 125 reflects elements or components and their respective attributes, as may be provided with the individual pages of the files 101. The user can edit the content 125 using the input interface 118. Alternatively, the rendering engine 120 can generate a blank page for the canvas 122, and the user can use the input interface 118 to generate the content 125. By way of example, the content 125 can include graphic elements such as a background and/or a set of objects (e.g., shapes, text, images, programmatic elements), as well as attributes of the individual graphic elements. Each attribute of a graphic element can include an attribute type and an attribute value. For an object, the types of attributes include, shape, dimension (or size), layer, type, color, line thickness, text size, text color, font, and/or other visual characteristics. Depending on implementation, the attributes reflect properties of two- or three-dimensional designs. In this way, attribute values of individual objects can define, for example, visual characteristics of size, color, positioning, layering, and content, for elements that are rendered as part of the content 125.

In examples, individual design elements may also be defined in accordance with a desired run-time behavior. By way of example, some objects can be defined to have run-time behaviors that are either static or dynamic. The attributes of dynamic objects may change in response to predefined run-time events generated by the underlying application that is to incorporate the content 125. Additionally, some objects may be associated with logic that defines the object as being a trigger for rendering or changing other objects, such as through implementation of a sequence or workflow. Still further, other objects may be associated with logic that provides the design elements to be conditional as to when they are rendered and/or their respective configuration or appearance when rendered. Still further, objects may also be defined to be interactive, where one or more attributes of the object may change based on user-input during the run-time of the application.

As described with examples, the interactive system 100 enables the user of plugins by users. A plugin can be selected and executed to perform a specific set of operations, and execution of the plugin can alter the content 125 on the canvas 122. For example, a plugin library can be stored on the user computing device 10 and/or stored on a network site which the interactive system 100. Further, in examples, plugins can be used to perform a task that is difficult or time-consuming. For example, in implementations where the system 100 enables creation of interactive graphic designs, plugins can be executed to create specific types of content graphic content elements (e.g., generate iconic representation of person, create interactive table, etc.). Still further, a plugin can be configured to perform a task of altering attributes of content elements. For example, a plugin can execute to implement a task that automatically replaces the occurrence of an attribute (e.g., fill color, line color, etc.) with another attribute. Still further, plugins can implement other types of tasks, such as exporting content elements or creating data sets (e.g., programmatic code) for specified content elements. Such examples illustrate the various ways plugins can be incorporated and used with an interactive system 100, such as described by various examples.

### Network Computing System

FIG. 1B illustrates a network computing system to implement an interactive system on a user computing device, according to one or more examples. A network computing system such as described with an example of FIG. 1B can be implemented using, for example, one or more servers which communicate with user computing devices over one or more networks.

In an example of FIG. 1B, the network computing system 150 perform operations to enable the interactive system 100 to be implemented on the user computing device 10. In variations, the network computing system 150 provides a network service 152 to support the use of the interactive system 100 by user computing devices that utilize browsers or other web-based applications. The network computing system 150 can include a site manager 158 to manage a website where a set of web-resources 155 (e.g., web page) are made available for site visitors. The web-resources 155 can include instructions, such as scripts or other logic (“system instructions 157”), which are executable by browsers or web components of user computing devices.

In some variations, once the computing device 10 accesses and downloads the web-resources 155, web-based application 80 executes system instructions 157 to implement functionality such as described with some examples of FIG. 1A. For example, the system instructions 157 can be executed by web-based application 80 to initiate the program interface 102 on the user computing device 10. The initiation of the program interface 102 may coincide with the establishment of, for example, a web-socket connection between the program interface 102 and a service component 160 of the network computing system 150.

In some examples, the web-resources 155 includes logic which web-based application 80 executes to initiate one or more processes of the program interface 102, causing the interactive system 100 to retrieve additional programmatic resources and data sets for implementing functionality as described by examples. The web resources 155 can, for example, embed logic (e.g., JAVASCRIPT code), including GPU accelerated logic, in an HTML page for download by computing devices of users. The program interface 102 can be triggered to retrieve additional programmatic resources and data sets from, for example, the network service 152, and/or from local resources of the computing device 10, in order to implement the interactive system 100. For example, some of the components of the interactive system 100 can be implemented through web-pages that can be downloaded onto the computing device 10 after authentication is performed, and/or once the user performs additional actions (e.g., download one or more pages of the workspace associated with the account identifier). Accordingly, in examples as described, the network computing system 150 can communicate the system instructions 157 to the computing device 10 through a combination of network communications, including through downloading activity of web-based application 80, where the system instructions 157 are received and executed by web-based application 80.

The computing device 10 can use web-based application 80 to access a website of the network service 152 to download the webpage or web resource. Upon accessing the website, web-based application 80 can automatically (e.g., through saved credentials) or through manual input, communicate an account identifier to the service component 160. In some examples, web-based application 80 can also communicate one or more additional identifiers that correlate to a user identifier.

Additionally, in some examples, the service component 160 can use the user or account identifier of the user identifier to retrieve profile information 109 from a user profile store 166. As an addition or variation, profile information 109 for the user can be determined and stored locally on the user's computing device 10.

The service component 160 can also retrieve the files of an active workspace (“active workspace files 163”) that are linked to the user account or identifier from a file store 164. The profile store 166 can also identify the workspace that is identified with the account and/or user, and the file store 164 can store the data sets that comprise the workspace. The data sets stored with the file store 164 can include, for example, the pages of a workspace, data sets that identify constraints for an active set of workspace files, and one or more data structure representations 161 for the design under edit which is renderable from the respective active workspace files.

Additionally, in examples, the service component 160 provides a representation 159 of the workspace associated with the user to the web-based application 80, where the representation identifies, for examples, individual files associated with the user and/or user account. The workspace representation 159 can also identify a set of files, where each file includes one or multiple pages, and each page including objects that are part of a design interface.

On the user device 10, the user can view the workspace representation through web-based application 80, and the user can elect to open a file of the workspace through web-based application 80. In examples, upon the user electing to open one of the active workspace files 163, web-based application 80 initiates the canvas 122. For example, the interactive system 100 can initiate an HTML 5.0 canvas as a component of web-based application 80, and the rendering engine 120 can access one or more data structures representations 111 to render or update the corresponding content 125 on the canvas 122.

With further reference to FIG. 1B, the network computing system 150 enables the user computing device 10 to implement a plugin sub-system 200. For example, the network computing system 150 can provide the computing device 10 with logic to cause the computing device 10 to implement the plugin sub-system 200. Further, in some examples, the network computing system 150 can store a library or collection of plugins that are made available to individual users through a search user interface, such as described with other examples. In this way, the user of computing device 10 can search for and execute desired plugins to extend or supplement the functionality of the interactive system 100.

### Collaborative Network Platform

FIG. 1C illustrates a network computing system to implement an interactive system for multiple users in a collaborative network platform, according to one or more examples. In an example of FIG. 1C, a collaborative network platform is implemented by the network computing system 150, which communicates with multiple user computing devices 10, 12 over one or more networks (e.g., World Wide Web) to implement the interactive system 100 on user computing devices 10, 12. While FIG. 1C illustrates an example in which two users utilize the collaborative network platform, examples as described allow for the network computing system 150 to enable collaboration on design interfaces amongst a larger group of users.

With respect to FIG. 1C, the user computing devices 10, 12 can be assumed as being operated by users that are associated with a common account, with each user computing device 10, 12 implementing an instance of the interactive system 100 to access the same workspace during respective sessions that overlap with one another. Accordingly, each of the user computing devices 10, 12 may access the same set of active workspace files 163 at the same time, with the respective program interface 102 of the interactive system 100 on each user computing device 10, 12 operating to establish a corresponding communication channel (e.g., web socket connection) with the service component 160.

In examples, the service component 160 can communicate a copy of the active workspace files 163 to each user computing device 10, 12, such that the computing devices 10, 12 render the content 125 of the active workspace files 163 at the same time. Additionally, each of the computing devices 10, 12 can maintain a local data structure representation 111 of the respective content 125, as determined from the active workspace files 163. The service component 160 can also maintain a network-side data structure representation 161 obtained from the files of the active workspace 163, and coinciding with the local data structure representations 111 on each of the computing devices 10, 12.

The network computing system 150 can continuously synchronize the active workspace files 163 on each of the user computing devices. In particular, changes made by each user to the content 125 on their respective computing device 10, 12 can be immediately reflected on the content 125 rendered on the other user computing device 10, 12. By way of example, the user of computing device 10 can make a change to the respective content 125, and the respective rendering engine 120 can implement an update that is reflected in the local copy of the data structure representation 111. From the computing device 10, the program interface 102 of the interactive system 100 can stream change data 121, reflecting the change of the user input, to the service component 160. The service component 160 processes the change data 121 of the user computing device. The service component 160 can use the change data 121 to make a corresponding change to the network-side data structure representation 161. The service component 160 can also stream remotely-generated change data 171 (which in the example provided, corresponds or reflects change data 121 received from the user device 10) to the computing device 12, to cause the corresponding instance of the interactive system 100 to update the content 125 as rendered on that device. The computing device 12 may also use the remotely generated change data 171 to update with the local data structure representation 111 of that computing device 12. The program interface 102 of the computing device 12 can receive the update from the network computing system 150, and the rendering engine 120 can update the content 125 and the respective local copy of 111 of the computing device 12.

The reverse process can also be implemented to update the data structure representations 161 of the network computing system 150 using change data 121 communicated from the second computing device 12 (e.g., corresponding to the user of the second computing device updating the content 125 as rendered on the second computing device 12). In turn, the network computing system 150 can stream remotely generated change data 171 (which in the example provided, corresponds or reflects change data 121 received from the user device 12) to update the local data structure representation 111 of the content 125 on the first computing device 10. In this way, the content 125 of the first computing device 10 can be updated as a response to the user of the second computing device 12 providing user input to change the content 125.

To facilitate the synchronization of the data structure representations 111, 111 on the computing devices 10, 12, the network computing system 150 may implement a stream connector to merge the data streams which are exchanged between the first computing device 10 and the network computing system 150, and between the second computing device 12 and the network computing system 150. In some implementations, the stream connector can be implemented to enable each computing device 10, 12 to make changes to the network-side data representation 161, without added data replication that may otherwise be required to process the streams from each device separately.

Additionally, over time, one or both of the computing devices 10, 12 may become out-of-sync with the server-side data representation 161. In such cases, the respective computing device 10, 12 can redownload the active workspace files 163, to restart its maintenance of the data structure representation of the content 125 that is rendered and edited on that device.

With further reference to FIG. 1C, the network computing system 150 enables each computing device 10, 12 to implement a plugin sub-system 200. For example, the network computing system 150 can communicate instructions to cause each computing device 10, 12 to implement the plugin sub-system 200 as part of the interactive system 100. Further, in some examples, the network computing system 150 can store a library or collection of plugins that are made available to users of computing devices 10, 12 through a search user interface, such as described with other examples. In this way, the user can search for and execute desired plugins to extend or supplement the functionality of the interactive system 100.

### Plugin Management System

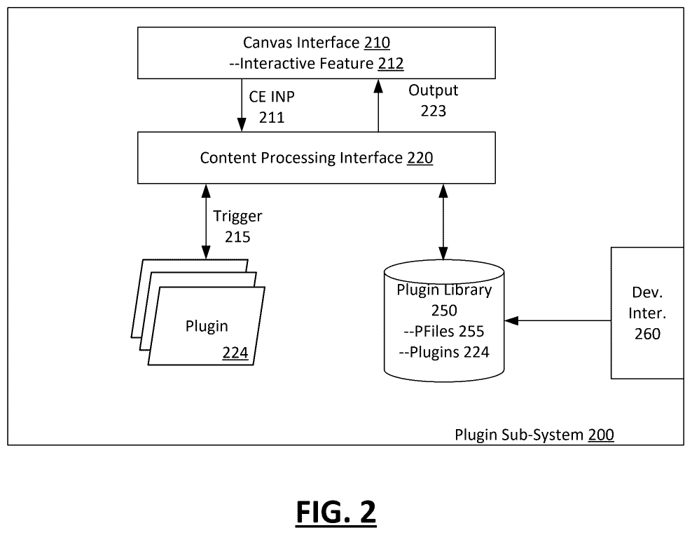

FIG. 2 illustrates a plugin management system for use with examples as described with FIG. 1A through FIG. 1C. In some examples, a plugin sub-system 200 is provided as part of the interactive system 100. In variations, the plugin sub-system 200 can be provided by, for example, the network computing system 150, in connection with users utilizing interactive system 100 on their respective computing devices 10, 12.

According to examples, the interactive system is configured to be extensible, for purpose of enabling execution of plugins from a plugin library. Each plugin can be implemented as a program that executes separately from the interactive system. The plugins can execute to augment or extend the functionality of the interactive system. An end user can, for example, execute a plugin in connection with utilizing the interactive system 100 and creating or updating a design or other content provided on a canvas 122,

As shown, the plugin sub-system 200 200 includes processes that, when implemented, provide functionality represented by canvas interface 210 and content processing interface 220. Further, the plugin sub-system 200 includes a plugin library 250 to provide a library or collection of plugins.

The plugin library 250 includes program files (e.g., executable files) which can execute at the selection of an end user in connection with the end user utilizing the interactive system 100 to create and/or update content rendered on a canvas. The plugins can be created by developers, including third-parties to a proprietor of the interactive system 100. In examples, each plugin can be executable at the option of a user to implement a process separate from the functionality of the interactive system 100. Accordingly, the plugins stored with the plugin library 250 can provide additional or enhanced functionality for use with interactive system 100.

In examples, a developer can interact with the plugin sub-system 200 to store a plugin file 255 (or set of files that are used at time of execution) with the plugin library 250. The plugin files 255 can include one or more executable files for execution of a corresponding plugin. A developer can utilize a developer interface 260 to add plugin files to the plugin library 250, as well as to update existing plugins. While some examples provide for plugins to be created by developers, in variations, plugins can also be designed and implemented by the creator of the interactive system 100. For example, the creator of the interactive system 100 can design plugins that enhance functionality of the interactive system 100, where the functionality is utilized by a relatively limited number of users.

### Plugin Detection and Execution

According to examples, canvas interface 210 provides features, such as may be generated by the rendering engine 120, and/or through other processes of the interactive system 100, to detect and process content entry input 211. The content entry input 211 can be input of a particular type (e.g., alphanumeric entry, such as entered through a key-strike) which results in a content element being rendered or changed on the canvas 122. For example, the interactive system 100 can render a design that includes graphic content, as well as text input, and the user can operate the interactive system 100 in text entry mode (as compared to graphic mode, where user enters visual elements such as shaped elements and frames) to enter text that forms part of the graphic design. Accordingly, canvas interface 210 can include programmatic processes to capture content entry input 211 (e.g., key strike input, such to generate an alphanumeric entry), where the content entry input 211 results in content being generated or modified on the canvas 122 (e.g., character entry).

Canvas interface 210 can also provide one or more interactive features 212 with the canvas 122. The interactive features 212 can be provided by interactive windows or menus, and/or design tools (e.g., panel feature(s)). As described in greater detail, interactive features 212 can include elements (e.g., options) that are configurable to display or otherwise indicate output generated by the canvas interface 210 and/or plugins 224. Additionally, interactive features 212 includes elements that are configurable by the output generated by the programmatic processes of the canvas interface.

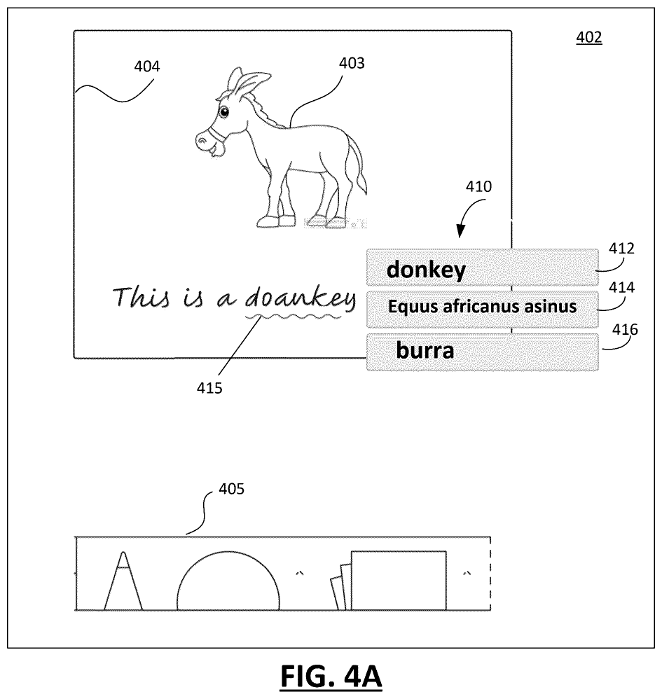

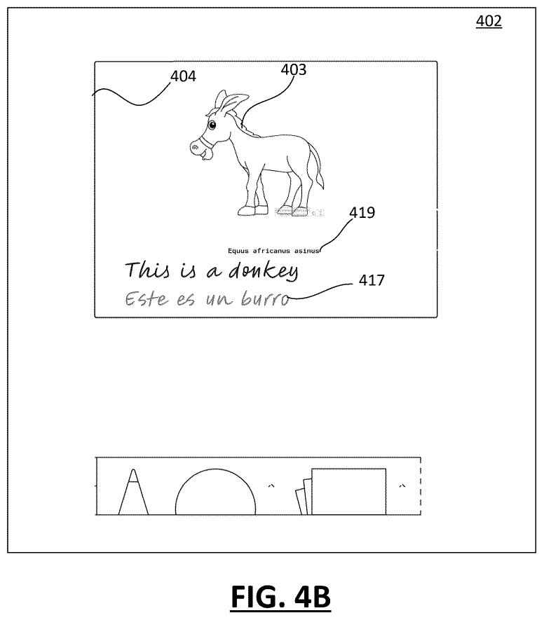

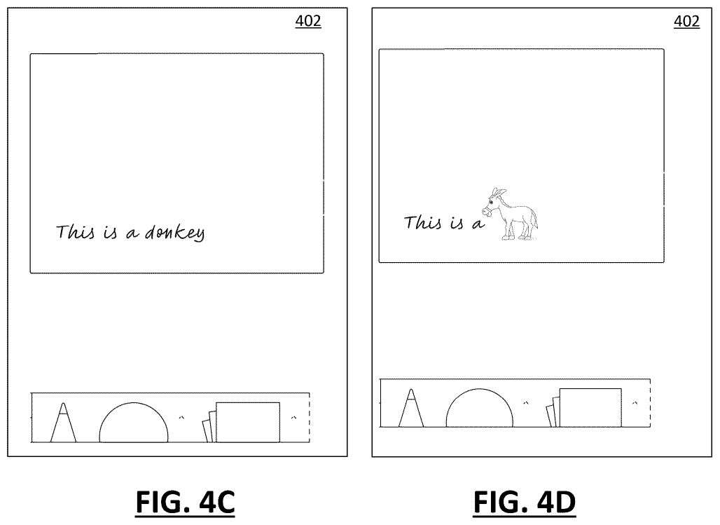

Content processing interface 220 triggers execution of one or multiple programmatic processes, including native program process(es) (or “native plugins”) and plugins 224 of a plugin library 250, based on or responsive to the content entry input 211. Content processing interface 220 can execute the plugins 224 to generate one or multiple plugin outputs 223, where each output (i) supplements or enhances content rendered on the canvas 122, and/or (ii) provides or modifies an interactive feature, or element thereof, for use with editing or manipulating content rendered on the canvas 122. As described with FIG. 4A through FIG. 4C, a plugin output 223 can include (i) an identification of a word, term, or character that appears on the canvas 122 and was processed by the respective plugin 224; (ii) a temporary visual element that overlays or appears with a content element of the canvas, such as an underlying or other text effect, which the canvas interface 210 can implement with the processed content (e.g., word, character, sentence, etc.); (iii) a menu or menu item that includes an output of the plugin, where the user can interact with the menu item to modify existing content of the canvas 122; and/or (iv) content that modifies the content of the canvas 122, such as text content that is inserted into the canvas 122 (e.g., to replace another text content).

Still further, in some variations, a given plugin can execute to generate functional elements that the user can interact with, alongside a process content item (e.g., word on the canvas 122). For example, the content processing interface 220 can trigger execution of a given third-party plugin, causing the plugin to generate functional interactive elements that can be combined with the interactive feature 212, or provided separately in a different interactive element or component (e.g., a separate menu, panel or graphic functional element) appearing alongside the interactive feature 212 (e.g., which may be generated by a native plugin or the like).

According to examples, the interactive system 100 enables a user to provide input for creating text content on canvas 122. For example, the interactive system 100 can include an interactive graphic design system to enable the user to create various types of visual elements and content, including text content. The graphic design system may be implemented to include multiple modes, including a text entry mode. In some examples, when text entry mode is implemented, canvas interface 210 identifies one or multiple predetermined plugins 224 where one or both of the plugins 224 are continuously or repeatedly executed automatically, in response to a given user input (e.g., a single alphanumeric key entry). The predetermined plugins can include, for example, a native programmatic process (e.g., native spellchecker), a third-party or developer plugin (e.g., spell checker for medical terms, prescriptions, etc.), or other examples as described below (see FIG. 4A through FIG. 4C).

Accordingly, after each character entry, content processing interface 220 executes one or multiple plugins 224. One or both plugins can execute to identify input to process. For example, each plugin 224 can generate instructions, or parameters for causing canvas interface 210 to identify a content item (e.g., word) of the current content entry 211 (e.g., character) for the corresponding plugin 224 to process. The content item processed by each plugin 224 can thus be the same or different. For example, canvas interface 210 can identify successive characters (e.g., [space][c][a][t]) after a space character, either by default or as a result of instructions/parameters generated by one or both plugins 224 that are selected or otherwise designated to execute automatically, in response to content entry of the user.

Alternatively, one or both plugins 224 can execute to cause canvas interface 210 to identify the content that is to be processed by the respective plugin. For example, based on parameters specified by the executing plugin, canvas interface 210 can identify a sentence, or a graphic element that embeds text content.

Content processing interface 220 can execute the plugin(s) 224 to generate, as corresponding output 223, visual elements that are displayed with the content that is processed by the respective plugins 224. For example, in the case where the plugin 224 is a spell checker, the output of the plugin 224 can be in the form of an underline for a word that is misspelled. To further the example, the plugin 224 can be a different spell checker that has, for example, a specialized library that is different than the library of the first plugin. In such case, the output of the plugin 224 can be a second visual element (e.g., second underline with squiggly) that is visually distinct from the output of the first plugin. The output 223 of the plugins 224 can thus be specified by the respective plugin, and further affect the appearance of the content on the canvas 122 (e.g., be a corresponding type of text affect that is applied to the processed text content). In some variations, the output 223, does not alter the content, but supplements the output with additional visual elements. In variations, the plugins may execute to generate outputs that alter the content (e.g., word appearing on canvas).

As an addition or alternative, content processing interface 220 executes to generate interactive features or elements that can be displayed with the canvas 122 (e.g., hover over the canvas 122), in order to display outputs of the respective plugins. As described with other examples, the outputs can include determinations on, for example, the spelling of a word, the grammar of an identified text segment or other content segment. The outputs can be used to populate a menu or interactive feature 212, to enable the user to selectively view corrections, alternative recommendations and the like.

In examples, canvas interface 210 and content processing interface 220 implement processes that run repeatedly, or continuously, responsive to user inputs. For example, canvas interface 210 can capture a single text character entry, and content processing interface 220 can identify corresponding text content (e.g., the character, a word containing the character etc.) to use in connection with executing a selected plugin 224. Canvas interface 210 and content processing interface 220 can repeat the process for the next character entry, such that for example, a spellcheck is performed on a series of characters until the characters complete a word (e.g., as may be delineated by space characters, or the presence of a space character followed by a punctuation, etc.). Content processing interface 220 can similarly implement an automated process that repeatedly or continually executes one or more plugins, such as from the plugin library 250, to analyze a corresponding word (e.g., a sequence of characters, uninterrupted by space character) as the user enters letters for the word. In variations, one or both (or more) of the plugins can be selectively executed by user. For example, a first plugin, corresponding to a native spellchecker, can execute continuously (e.g., in response each character entry of the user), and the user can interact with an interactive feature generated by content processing interface 220 to selectively execute the second (or additional) plugin from the plugin library 250. Thus, for example, the native plugin can generate an output that is a recommendation (e.g., such as may be displayed in an interactive menu for the user), and the user can selectively execute the second plugin to determine a synonym for the word or term that is flagged by the first plugin.

In examples, content processing interface 220 includes logic to consolidate output generated by multiple plugins. For example, content processing interface 220 can implement logic that prioritizes, or causes an output of one plugin to be superseded by the output of the other plugin. Alternatively, content processing interface 220 can combine the outputs of multiple plugins. For example, in an example where each plugin corresponds to a particular type of spellchecker, in output of each plugin can result in a corresponding visual element that indicates an error or alternative for the user to consider. Each of the visual elements can be different, based on the parameters of the respective plugin. Further, each plugin can generate a menu item, data to populate a menu item, or other interactive element that can be displayed in the user interface panel or menu, and which a user can interact with, in order to enable the user to view an output of the each plugin (e.g., view correction, recommended action, etc.). Subsequent interaction with for example the menu item can cause canvas interface 210 to trigger a change to the content rendered on the canvas 122.

### Methodology

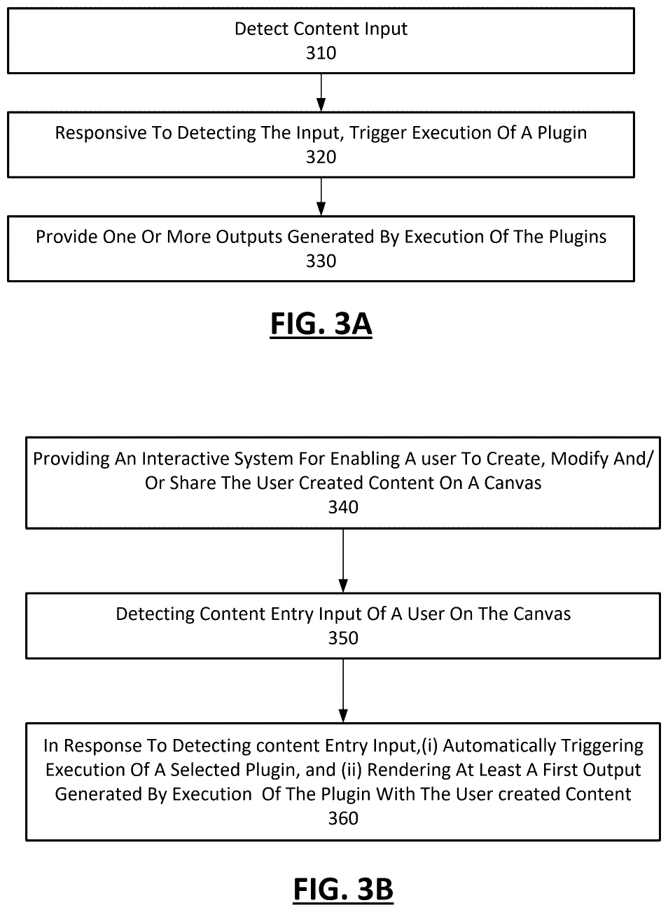

FIG. 3A and FIG. 3B describe example methods for executing plugins in connection with content entry on a canvas, according to one or more embodiments. An example methods such as shown with FIG. 3A and FIG. 3B can be implemented in connection with an interactive system or platform, such as described with FIG. 1A through FIG. Accordingly, reference is made to elements of FIG. 1A to FIG. 1C and FIG. 2 for purpose of illustrating a suitable component for performing a step or sub-step being described.

In step 310, content input is detected. The interactive system can include native functionality, such as event listeners, which detect specific types of content entry, such as text entry, or entry of specific graphic elements, such as frames etc. The interactive system 100 can be configured to detect such events, such as entry a particular types of content elements. Further, the interactive system 100 can be designed to be extensible, through use of plugins that can interface with interactive system in real-time, while users are using the interactive system 100 to create or modify a graphic design on a canvas. Each plugin can correspond to a program that executes separately from the interactive system 100, to enhance functionality of the interactive system.

In response to detecting the content input, in step 320, one or more plugins are triggered to execute automatically in response to content entry or another event. At least one of the executed plugins can be preselected by, for example, a user or administrator, to execute automatically in response to particular type of event, (e.g., detection of a content entry, such as text entry etc.).

Execution of the plugins result in the one or more outputs. In step 330, the interactive system 100 includes processes that interface with the plugins to receive a plugin output, and the output can be provided on or with the canvas. For example, the output of the plugins can be used to configure menu items from which the user can select to perform additional operations, including modifying content appearing on the canvas. As an addition or variation, the output of the plugins can be used to generate temporary content or visual elements that appear on the canvas, in connection with, for example, a content element that provided input for the plugin. Still further, the output of the plugins can be used to automatically modify the user-generated content of the content. For example, in the case of a graphic design, the output of the plugins can automatically modify the content written to the canvas by other users. For example, a word or phrase that appears as part of the content of the canvas can be replaced or modified. An attribute of a graphic element (e.g., a frame) can be modified or change, a frame or other graphic element can be replaced, or new content elements (e.g., a term, a frame, and average etc.) can be added as new content to the existing content of the canvas.

With reference to an example of FIG. 3B, in step 340, the interactive system 100 enables a user to create, modify, and/or share a user created content provided on a canvas. In some examples, the user criticality can be in the form of a graphic design, which can include objects in graphic elements, as well as textual content.

In step 350, content entry input of the user on the canvas can be detected. As described with various examples, the detection of content entry can be implemented by native processes or functionality of the interactive system 100, by another plugin, and/or by a user selected plugin that execute automatically in response to the content entry.

In step 360, in response to detecting content entry input, the interactive system 100 can automatically trigger execution of a user-selected or designated plugin. In response, at least a first output generated by the execution of the plugin is rendered with the user created content. The interactive system can integrate the output of the executing plugin in any one of multiple ways. For example, the interactive system 100 can generate a menu, menu item or tool that reflects an output of the plugin. Subsequent interaction by the user with respect to the menu item or tool can cause interactive system to integrate the output of the plugin by, for example, writing content to the canvas, and/or modifying existing content of the canvas to reflect the output of the plugin. In other examples other types of operations can be performed. In variations, the output of the plugin can be integrated by generating temporary content that is rendered with existing content of the canvas, such as existing content reflecting a trigger for the plugin's execution. As another variation, the interactive system 100 can integrate the output of the plugin by directly modifying the graphic design or user-generated content appearing on the canvas based on the output of the plugin.

### Examples

In some examples, the interactive system 100 can enable plugins that automatically execute in response to predetermined events, such as the entry of a character. The plugins can utilize an event listener functionality, which may be included in the native functionality of the interactive system. In other examples, the selected plugins can execute through use of a default plugin. In examples where events related to textual content entry of a user, the selected plugins can enable the user to employ multiple types of spellcheckers, each of which execute automatically responsive to events detected through the plugin, a default plugin, or native functionality of the interactive system (e.g., an event listener function). Select plugins can be created or configured for specialized applications (e.g., medical, legal, technical) or for a particular type of user (e.g., for an enterprise). Further, in such examples, the spellcheckers can be concurrently executed, along with a native spellchecker. Further, the functionality of the native spellchecker (e.g., identifying range of characters to check, providing event listener, e.g.) can be used to leverage the functionality and output that can be provided through the second plugin (e.g., provided by third party). Additional examples are provided below.

FIG. 4A through FIG. 4B illustrate example interfaces which can be generated for a canvas, according to one or more embodiments. In examples shown, a canvas 402 includes design elements 403, 404. Further, a tool bar menu 405 can be provided with the canvas 402 to enable the user to create additional design elements and/or edit existing design elements on the canvas.

In an example of FIG. 4A, multiple plugins are executed automatically in response to content entry of a particular type (e.g., text), where the content entry corresponds to the user entering a sequence of characters to form a word or phrase that includes multiple words. Individual plugins that execute can generate, as output, an interface overlay to enable the user to perform additional operations utilizing the detected content entry. In an example shown, the interface overlay corresponds to individual menu items 412, 414, 416 that each represent an operation or command the user can select to perform. The menu items 412, 414, 416 can populate a menu structure 410. The menu structure 410 can be sized vertically or horizontally to accommodate the output of individual plugins. In the example shown, three plugins execute automatically to generate corresponding menu item, illustrating that the menu 410 can be vary in size and content based on the plugins the user selects to execute automatically.

In examples, the interactive system 100 can include a set of default plugins for use with specific types of content input (e.g., text entry). For example, for text entry, the default plugin of the interactive system may correspond to a spellchecker. As described with examples, with each character entry, the default spell checker plugin executes by (i) determining whether a word has been entered (e.g., by checking whether a space or punctuation follows the last character entry), (ii) determining whether the word is spelled correctly (e.g. by checking the word entry against a dictionary), and (iii) generating one or more outputs for the user. The outputs for the user can include a menu item 412 that identifies a correctly spelled word (i.e., ‘donkey’), and/or a visual indicator 415 that overlays the canvas at or near the misspelled word. In an example of FIG. 4A, the user can interact with the menu item 412 to cause the identified word of the menu item 412 to replace the misspelled word on the canvas. However, in variations, an output of the default plugin can automatically replace the misspelled word.

In examples, the user can select additional plugins that execute automatically with the default plugin. In an example of FIG. 4A, the additional plugins can execute based on an output of the default plugin (e.g., the spellchecker). Thus, in an example shown, the user-selected plugins can be triggered to execute based on, and/or using an output of the default plugin. The menu item 414, for example, illustrates an output of a scientific dictionary where common words are selectively replaced by a scientific term. When the user misspells a word, the plugin represented by menu item 414 can execute automatically by, for example, (i) using an output of the default plugin to check a scientific dictionary for the proper scientific name of the misspelled word, and (ii) if a proper scientific name is found, generate a corresponding menu item that includes the name. Upon selection of the menu item 414, the word “doankey” may be replaced with “Equus africanus asinus”. Similarly, a second user selected plugin can receive an output from the spellchecker (“donkey”) and automatically translate the corrected word into another language designated by the user (e.g., Spanish).

While an example of FIG. 4A provides for additional user selected plugins to be triggered to execute using an output of the default plugin, in variations, the additional plugins can execute without the output generated by the default plugin. For example, if no word is misspelled, the default plugin can still execute to check the spelling of the word, but the output of the default plugin is not rendered because the word was not misspelled. Thus, in examples, the additional user-selected plugins can interface with the default plugin to receive the checked word, even when the word is spelled correctly. Still further, in some examples, the default plugin can utilize a native functionality of the interactive system which identifies the formation of words. In examples, user selected plugins can interface with the native process to receive words detected by the process. Thus, the user selected plugins can be executed independently or without the output of the native plugin. In additional variations, the user selected plugins can detect when certain types of content is entered by the user (e.g., word or phrase). The user selected plugins can implement a process for checking for particular types of content in response to the user's content entry. For example, the user selected plugins can check for the formation of a word after each character entry of the user (e.g., by checking for characters between spaces, or between spaces and punctuation, etc.). Further, the user selected plugins can include additional layers of logic, for purpose of filtering out content entries which are not intended to be subject to the plugin. For example, a scientific dictionary plugin can execute after each character entry to (i) detect whether a word has been formed, (ii) detect whether the form wars has indicators of a noun, (iii) search a scientific dictionary for the presence of the an detected word, and (iv) generate an output if a match is found.

FIG. 4B illustrates a variation to an example of FIG. 4A, where user-selected plugins are executed automatically, without a default plugin generating an output on the canvas. As shown, in some examples, the user selected plugins can execute independently of a default plugin (e.g., without receiving an output of the plugin).

FIG. 4B also illustrates a variation in which an output of the user selected plugin, results in temporary content that does not modify the underlying design of the canvas. In an example shown, an output generated by the execution of the user selected plugins can be provided as, for example, textual content that temporarily overlays the detected word that was used for input to the execute a plugin. In the specific example provided, the output of a Spanish translation plugin can be the generation of temporary content providing the translation 417 for a phrase, where the translation is updated upon the detection of each new word. The scientific dictionary plugin can detect a noun and temporarily render the scientific term 419 for the word. In some examples, the user can interact with the temporary content to modified the content of the canvas 402. For example, the user can select the translation 417 to replace the phrase “this is a donkey”.

Still further, in some examples, the user selected plugins can execute automatically to modify content of the canvas 400 to automatically, upon detection of a particular content entry. FIG. 4C and FIG. 4D illustrate a sequence where a detected content element or entry (e.g., detected word) is replaced by an image, according to one or more examples. In such an example, a selected plugin analyzes text entry of the user (or alternatively, uses an output of a native process or default plugin) to identify individual words, and then replaced the detected words with an image from, for example, an image library. In the example shown, the word “donkey” is automatically replaced with the graphic or image depicting a donkey. The execution of the selected plugin can include searching the image library for an image that matches to the word input, then replacing the word with the identified image. The result can modify the design of the content—in other words, the identified image is written to modify graphic design of the canvas. Thus, the selected plugin can execute automatically to process textual input and replace text content (e.g., the word “donkey”) with another content element (e.g., graphic of a donkey). In variations, the graphic can be presented as a temporary content element (e.g., either in a menu or as an overlay, with the user can then select to trigger the content modification to the canvas 402.

While various examples are described in context of automatically executing plugins in response to content entry that is text, in variations, the user selected plugin can execute to analyze content entry of other types, and perform operations or functions based on the detected content entry. For example, the plugin can execute to detect an attribute, such as a shape, fill or line color, line thickness, or other attribute or characteristic (e.g., a frame parenting another object or frame, etc.) (“triggering content entry”). Upon detection of the triggering content entry, the plugin executes to perform a function. The function may utilize an input, such as the triggering content entry. As described with other examples, the function performed by the plugin can include (i) generating a menu or other overlay that enables the user to view or select an output of the selected plugin; (ii) generating temporary content that overlays the graphic design or content of the canvas (e.g., an image overlay), and optionally enables the user to select the overlay content as as an insertion, replacement or other modification to the content of the canvas; and/or (iii) automatically modifying the content of the canvas using the output of the selected plugin.

By way of illustrative examples, a plugin can be designed to detect a specific graphic element, such as a shape, or combination of a shape and fill color etc. Upon detecting the graphic element, the plugin executes a predetermined operation, such as an operation to (i) replace the detected graphic element with a different graphic element, or (ii) modify the detected graphic element to have a different attribute. As a specific example, a plugin can scan graphic elements of the canvas (or the underlying data structure) to identify a fill color of a particular hue. Upon detecting the particular hue the plugin automatically replaces or modifies the hue with a different hue. In this way, an enterprise, for example, can configure the interactive system to automatically implement a plugin, for purpose of implementing branding safeguards with the interactive system—specifically, where the plugin detects hues in content elements of graphic designs that are offensive or contrary to the branding of the enterprise, and replaces the hues with non-offensive or promoted hues.

As another example, a plugin can be designed to detect a simplified design element, such as a circle having a predetermined set of attributes (e.g., shape, fill, etc.). Upon the selected plugin detecting the shape being entered onto the canvas, the plugin executes an operation to replace the design element with an icon of a human head. The features of the human head can be based on, for example, text content that appears on the canvas near the triggering content element (e.g., in-line, preceding the design element). Alternatively, in the example provided, the plugin can execute to generate a menu or interface where the user can specify variables for the human head, such as age range, sex, hair color, etc., and the resulting image can replace the design element on the canvas.

### Network Computer System

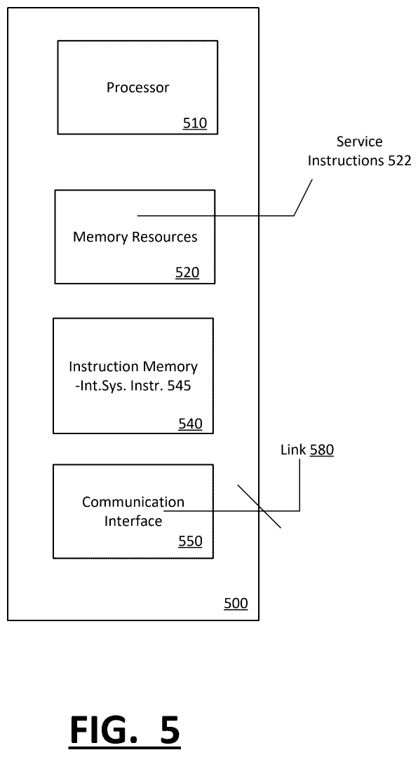

FIG. 5 illustrates a computer system on which one or more embodiments can be implemented. A computer system 500 can be implemented on, for example, a server or combination of servers. For example, the computer system 500 may be implemented as the network computing system 150 of FIG. 1A through FIG. 1C, and further utilized by a plugin sub-system 200 of FIG. 2.

In one implementation, the computer system 500 includes processing resources 510, memory resources 520 (e.g., read-only memory (ROM) or random-access memory (RAM)), one or more instruction memory resources 540, and a communication interface 550. The computer system 500 includes at least one processor 510 for processing information stored with the memory resources 520, such as provided by a random-access memory (RAM) or other dynamic storage device, for storing information and instructions which are executable by the processor 510. The memory resources 520 may also be used to store temporary variables or other intermediate information during execution of instructions to be executed by the processor 510.

The communication interface 550 enables the computer system 500 to communicate with one or more user computing devices, over one or more networks (e.g., cellular network) through use of the network link 580 (wireless or a wire). Using the network link 580, the computer system 500 can communicate with one or more computing devices, specialized devices and modules, and/or one or more servers.

In examples, the processor 510 may execute service instructions 522, stored with the memory resources 520, in order to enable the network computing system to implement the network service 152 and operate as the network computing system 150 in examples such as described with FIG. 1A through FIG. 1C.

The computer system 500 may also include additional memory resources (“instruction memory 540”) for storing executable instruction sets (“interactive system instructions 545”) which are embedded with web-pages and other web resources, to enable user computing devices to implement functionality such as described with the interactive system 100.

As such, examples described herein are related to the use of the computer system 500 for implementing the techniques described herein. According to an aspect, techniques are performed by the computer system 500 in response to the processor 510 executing one or more sequences of one or more instructions contained in the memory 520. Such instructions may be read into the memory 520 from another machine-readable medium. Execution of the sequences of instructions contained in the memory 520 causes the processor 510 to perform the process steps described herein. In alternative implementations, hard-wired circuitry may be used in place of or in combination with software instructions to implement examples described herein. Thus, the examples described are not limited to any specific combination of hardware circuitry and software.

### User Computing Device

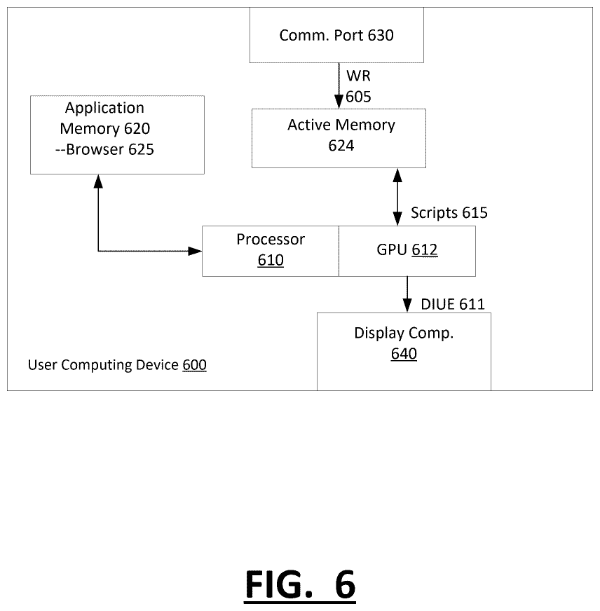

FIG. 6 illustrates a user computing device for use with one or more examples, as described. In examples, a user computing device 600 can correspond to, for example, a workstation, a desktop computer, a laptop or other computer system having graphics processing capabilities that are suitable for enabling renderings of design interfaces and graphic design work. In variations, the user computing device 600 can correspond to a mobile computing device, such as a smartphone, tablet computer, laptop computer, VR or AR headset device, and the like.

In examples, the computing device 600 includes a central or main processor 610, a graphics processing unit 612, memory resources 620, and one or more communication ports 630. The computing device 600 can use the main processor 610 and the memory resources 620 to store and launch a browser 625 or other web-based application. A user can operate the browser 625 to access a network site of the network service 152, using the communication port 630, where one or more web pages or other resources 605 for the network service 152 (see FIG. 1A through FIG. 1C and FIG. 2) can be downloaded. The web resources 605 can be stored in the active memory 624 (cache).

As described by various examples, the processor 610 can detect and execute scripts and other logic which are embedded in the web resource in order to implement the interactive system 100 (see FIG. 1A through FIG. 1C). In some of the examples, some of the scripts 615 which are embedded with the web resources 605 can include GPU accelerated logic that is executed directly by the GPU 612. The main processor 610 and the GPU can combine to render content 611 on a display component 640. The rendered design interface can include web content from the browser 625, as well as design interface content and functional elements generated by scripts and other logic embedded with the web resource 605. By including scripts 615 that are directly executable on the GPU 612, the logic embedded with the web resource 605 can better execute the interactive system 100, including the plugin sub-system 200, as described with various examples.

### CONCLUSION

Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A network computer system comprising:
one or more processors;
a memory to store a set of instructions;
wherein the one or more processors access the instructions from the memory to perform operations that include:
providing an interactive system for enabling one or more users to create, modify and/or share user-created content on a canvas;
detecting content entry input of a user on the canvas;
in response to detecting content entry input, (i) automatically triggering execution of a plugin, the plugin being implemented as a program that executes separately from the interactive system; and (ii) rendering at least a first output generated by execution of the plugin with the user-created content.

2. The network computer system of claim 1, wherein providing at least the first output includes modifying a rendering of a content item that includes the content entry input.

3. The network computer system of claim 2, wherein the content entry input includes an alphanumeric entry, and wherein modifying the rendering includes modifying an appearance of a set of alphanumeric entries that are rendered on the canvas, the set of alphanumeric entries including the content entry.

4. The network computer system of claim 1, wherein the operations further comprise:
providing a user-interface feature in connection with the content entry input on the canvas; and
wherein providing the output includes modifying the user-interface feature to include the output generated by execution of the output.

5. The network computer system of claim 4, wherein providing the output includes supplementing a menu feature with one or more options to enable the user to select to modify the user-created content based on the output.

6. The network computer system of claim 4, wherein providing the output includes generating a second user-interface feature that includes one or more elements generated by execution of the plugin.

7. The network computer system of claim 1, wherein the operations further comprise:
maintaining a data store that identifies a plurality of plugins; and
selecting, by default, preference or user input, one of the plurality of plugins to execute in response to the content entry input.

8. The network computer system of claim 1, wherein the content entry input includes a key strike; and wherein execution of the plugin is performed in response to the detected key strike.

9. The network computer system of claim 1, wherein the content entry corresponds to a text content entered on the graphic design.

10. The network computer system of claim 1, further comprising:
in response to triggering execution of the plugin results, implementing one or more operations specified by execution of the plugin to identify input for processing by the plugin.

11. The network computer system of claim 1, wherein b) includes triggering multiple plugins, and wherein c) includes providing one or more outputs, resulting from execution of the multiple plugins.

12. The network computer system of claim 11, wherein c) includes providing the first output generated by execution of the first plugin, and a second output generated by execution of the second plugin.

13. The network computer system of claim 11, wherein c) includes executing the first plugin to obtain the first output, executing the second plugin to obtain the second output, and selecting between the first output and the second output.

14. The network computer system of claim 11, wherein c) includes executing the first plugin to obtain the first output, executing the second plugin to obtain the second output, and combining the first output and the second output.

15. The network computer system of claim 11, wherein the first output and/or the second output include a visual element that is rendered with the canvas.

16. The network computer system of claim 2, wherein the modified rendering of the content item does not modify the user-created content on the canvas.

17. A method for implementing a plugin, the method being implemented by one or more processors and comprising:
providing an interactive system for enabling one or more users to create, modify and/or share user-created content on a canvas;
detecting content entry input of each of the one or more users on the canvas;
in response to detecting each content entry input, (i) automatically triggering execution of a plugin, the plugin being implemented as a program that executes separately from the interactive system; and (ii) rendering at least a first output generated by execution of the plugin with the user-created content.

18. A non-transitory computer-readable medium that stores instructions, which when executed by one or more processors, causes a computer system of the one or more processors to perform operations that include:
providing an interactive system for enabling one or more users to create, modify and/or share user-created content on a canvas;
detecting content entry input of each of the one or more users on the canvas;
in response to detecting each content entry input, (i) automatically triggering execution of a plugin, the plugin being implemented as a program that executes separately from the interactive system; and (ii) rendering at least a first output generated by execution of the plugin with the user-created content.
